(19) United States
(12) Patent Application Publication
(10) Pub. No.: US 2011/0178635 A1
(43) Pub. Date: Jul. 21, 2011

(54) ICE MITIGATING ROBOT

(76) Inventors: Noel Wayne Anderson, Fargo, ND (US); Jeffrey S. Puhalla, Hawley, MN (US); Peter Finamore, Weddington, NC (US)

(21) Appl. No.: 12/690,222

(22) Filed: Jan. 20, 2010

(51) Int. Cl. G05B 19/04

(52) U.S. Cl. 700/253

(57) ABSTRACT

An apparatus and method for detecting the presence of a slippery material, such as ice, on a surface and for taking action to mitigate the potential hazard presented by such material automatically with little or no human intervention. In accordance with an illustrative embodiment, a mobile machine, such as a robot, is controlled to move automatically across a surface along a path. The mobile machine automatically detects for the presence of a slippery material on the surface as it traverses the surface. The mobile machine automatically takes an action to mitigate the slippery material in response to the detection of the slippery material on the surface.

### FIELD OF THE INVENTION

The present invention relates generally to systems and methods for detecting the presence of ice on a surface and systems and methods for mitigating surface ice, and more particularly to a robot for detecting and mitigating surface ice automatically with minimal or no human intervention.

### BACKGROUND OF THE INVENTION

Robots include mobile teleoperated, supervised, and fully autonomous mobile machines of all sizes. Such mobile robots are used to perform a variety of functions. For example, smaller mobile robots of this type may be used for a variety of purposes around the home or office, such as delivering mail, mowing the lawn, and vacuuming floors.

Basic mobile robots typically include a means of locomotion and power, a task payload, a control system including a path definition, and means of perception for localization and safeguarding. For example, robot locomotion and power may be provided by an electric motor or engine and means for coupling the motor or engine to wheels, tracks, or legs to propel the robot across a surface.

The robot task payload defines the main useful function of the robot. For example, the task payload may include mower blades or a vacuum. Power for the task payload may be provided by the same motor or engine used to propel the robot or from another source of power.

The robot control system controls the direction and speed of movement of the robot through a defined path. The control system may also control operation of the robot task payload. The control system may be implemented using programmable components and may operate with minimal or no human intervention.

The robot may be controlled to traverse a path by moving between defined points or to cover a defined area using either precise localization or following a random pattern. In order to follow a defined path, the robot controller may receive input from a means of perception for localization, so that the location of the robot with respect to the defined path may be determined. Such means for perception for localization may include, for example, means for detecting a wire, marking, or signal that defines the path to be followed, optical or other means for detecting placed or natural landmarks having known positions and from which the robot location may be determined by triangulation, and/or localization means making use of the Global Positioning System (GPS).

A mobile robot typically also employs a means of perception for safeguarding to prevent damage to the robot and to things in the robot's environment. Such means of perception for safeguarding may include optical, sonic, and/or physical contact sensors that provide signals to the robot controller from which the presence of potentially damaging situations may be detected. The robot controller may stop the robot or alter its direction and/or speed of movement in response to the detection of a potentially damaging situation.

Various systems and methods for detecting the presence of ice on a surface are known. Some of these methods employ a signal reflected from the surface to detect the presence of ice without contacting the surface to be examined. For example, such a system may direct radiation having certain frequency or other characteristics at a surface and detect the return signal reflected from the surface. The return signal is then analyzed or processed for characteristics indicating that the signal has been reflected from ice on the surface. Optical and microwave frequency signals are known to be employed for ice detection in this manner.

It is also known practice to employ a physical structure, such as a roller or drag wheel, in contact with a surface to determine a level of adhesion or friction versus slipperiness of the surface.

### SUMMARY

An apparatus and method for detecting the presence of a slippery material, such as ice, on a surface and for taking action to mitigate the potential hazard presented by such material automatically with little or no human intervention is disclosed.

An apparatus in accordance with an illustrative embodiment includes a body, movable ground engaging structures, such as wheels, tracks, or legs, attached to the body, a motor coupled to the moveable ground engaging structures and configured to drive the moveable ground engaging structures to move the apparatus across a surface, a detector configured to detect a slippery material, such as ice, on the surface, and a controller. The controller is coupled to the detector and configured to control automatically movement of the apparatus across the surface along a path, and to control the apparatus to perform automatically an action to mitigate the slippery material in response to the detection of the slippery material on the surface.

A method in accordance with an illustrative embodiment comprises providing a mobile machine including a detector configured to detect a slippery material, such as ice, on a surface, controlling automatically movement of the mobile machine across the surface along a path, automatically detecting for a slippery material on the surface as the mobile machine is moved across the surface, and automatically performing an action to mitigate the slippery material in response to the detection of the slippery material on the surface.

The features, functions, and advantages can be achieved independently in various embodiments of the present invention or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and advantages thereof, will best be understood by reference to the following detailed description of illustrative embodiments of the present invention when read in conjunction with the accompanying drawings, wherein:

FIG. 1 is a block diagram of structural and functional components of an ice mitigating robot in accordance with an illustrative embodiment;

FIG. 2 is a side view representational illustration in partial cross section of an ice mitigating robot and base station therefore in accordance with an illustrative embodiment;

FIG. 3 is a representational illustration of an ice mitigating robot in accordance with an illustrative embodiment shown from above in operation detecting and mitigating ice on walkway and parking lot surfaces;

FIG. 4 is a flowchart of an automatic movement control method implemented in an ice mitigating robot in accordance with an illustrative embodiment; and

FIG. 5 is a flowchart of an ice detection and mitigation method implemented in an ice mitigating robot in accordance with an illustrative embodiment.

### DESCRIPTION OF THE PREFERRED EMBODIMENT

An ice mitigating robot in accordance with an illustrative embodiment is disclosed. A robot in accordance with an illustrative embodiment is a mobile machine that may operate automatically, with little or no human intervention, to move across a defined surface, such as a walkway or parking lot. As the robot traverses the surface, it automatically detects for the presence of potentially hazardous ice thereon and automatically takes action to mitigate the hazard when ice is detected.

Application of a robot in accordance with an illustrative embodiment is not limited to the detection and mitigation of ice on a surface. A robot in accordance with an illustrative embodiment may be used to detect other ice like substances, such as packed snow, on a surface, and/or to detect other slippery or low friction substances, such as grease or oil, on a surface, and to take appropriate mitigating action in response to the detection of such slippery material.

The different illustrative embodiments recognize and take into account a number of different considerations. For example, the different illustrative embodiments recognize and take into account that slipping on ice on a walkway or in a parking lot is a leading cause of injuries in many locations and is a major problem in northern areas of the United States. Dangerous ice formation can occur at any time. Therefore, it is desirable to provide a means in accordance with an illustrative embodiment for the detection and mitigation of ice on a surface that can operate continuously and automatically, with minimal or no human intervention, whenever conditions indicate that hazardous ice formation is likely or possible.

The different illustrative embodiments also recognize and take into account that various chemicals or other materials, including salts, that are used effectively to mitigate ice, may have adverse environmental effects, particularly in certain sensitive areas, and in general may be damaging to desirable plant life, such as landscaping plants and lawns. Thus, a means for employing such effective ice mitigation materials in a manner that reduces the amount of materials used also is desired. An ice mitigating robot in accordance with an illustrative embodiment is able to detect the precise location of ice patches on a surface and to deliver effective ice mitigation material only where needed, thereby reducing environmental exposure to such materials as well as the amount of such materials that must be purchased. Thus, for example, by employing an ice mitigating robot in accordance with an illustrative embodiment, it is no longer necessary to spread salt or another similar material over an entire parking lot surface spotted with patches of ice in order to ensure that all of the ice patches are covered with the ice mitigation material.

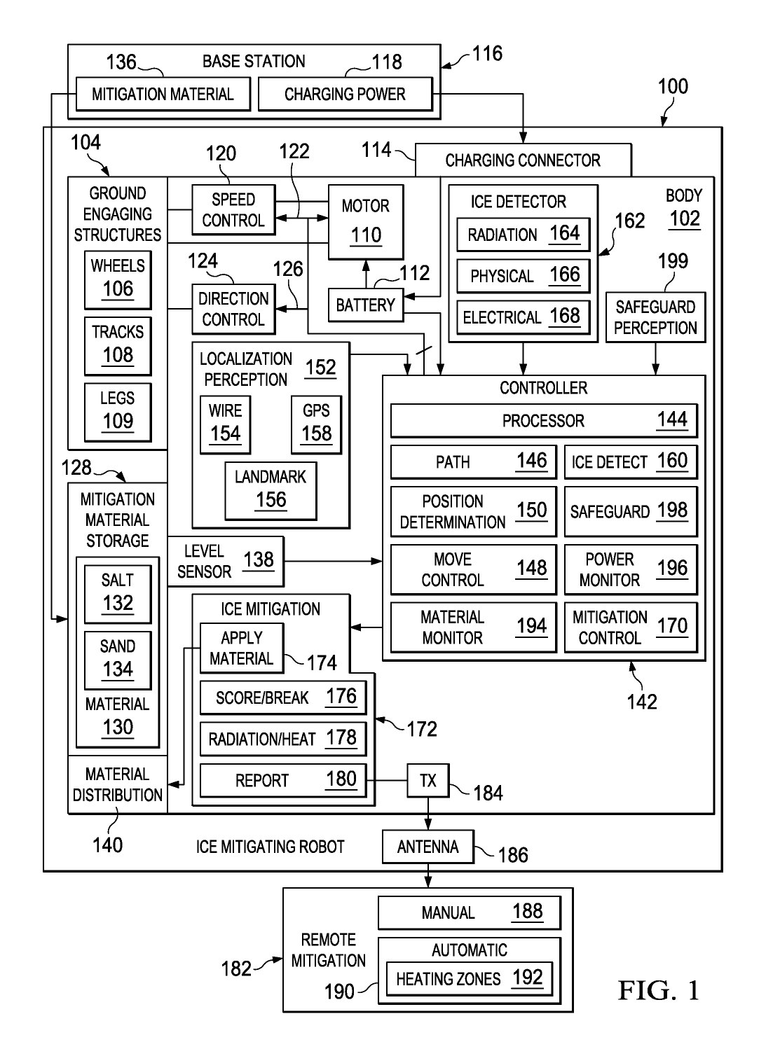

Structural and functional components of ice mitigating robot 100 in accordance with an illustrative embodiment are described with reference to FIG. 1. Ice mitigating robot 100 is one example of an automated mobile machine in accordance with an illustrative embodiment.

Ice mitigating robot 100 includes body 102 or frame. Movable ground engaging structures 104 are attached to body 102. Examples of moveable ground engaging structures 104 include conventional wheels 106, continuous and/or segmented tracks 108, and legs 109. Any desired number of moveable ground engaging structures 104 of any desired type, or multiple types, may be employed to support body 102, depending, for example, on the size, weight, operating environment, and/or application of robot 100.

Motor 110 mounted on body 102 is coupled to movable ground engaging structures 104 to impart motion to movable ground engaging structures 104, thereby to propel robot 100 across a surface, such as a walkway and/or a parking lot. Motor 110 may be coupled to impart motion to one, some, or all of ground engaging structures 104. Motor 110 may include any type of machine used to provide mechanical motion. Motor 110 may include, for example, an electric motor, gasoline engine, diesel engine or any hybrid electric system. Motor 110 may comprise one or more conventional individual motors and/or engines of different or the same types. The number, size, and types of machines used to implement motor 110 will depend upon such factors as the size, weight, and operating environment of robot 100.

Where motor 110 includes an electric motor, power for motor 110 may be provided by one or more rechargeable batteries 112. Any type and/or capacity of battery 112 may be used, depending upon motor 110 to be powered and the desired range and/or time of operation of robot 100 between charges of battery 112. Charging connector 114 may be provided on body 102 and connected to battery 112 so as to allow for charging of battery 112 when robot 100 is positioned in base station 116, as will be described in more detail below, or by some other means. Charging connector 114 provides for an electrical connection to charging power 118 provided by base station 116 or to some other source of charging power, such as a conventional electrical outlet. Charging connector 114 may provide for a physical electrical connection or for transfer of battery charging power to robot 100 wirelessly or otherwise without a physical connection. Charging connector 114 also may include conventional battery charging components, such as for controlling charging rate of battery 112, preventing overcharging, etc. Alternatively, such battery charging components may be provided as part of charging power components 118 in base station 116 or may be distributed between base station 116 and robot 100 in some other manner.

Motor 110 may be coupled to one or more movable ground engaging structures 104 via speed control mechanism 120. For example, speed control mechanism 120 may include one or more sets of gears or other structures for coupling mechanical motion from motor 110 to one or more movable ground engaging structures 104. By engaging and disengaging the gears or other structures in a known manner, the speed at which movable ground engaging structures 104 are moved by motor 110, and thus the speed of robot 100, may be adjusted. Speed control mechanism 120 may provide for a plurality of forward or forward and reverse movement speeds. Different individual ones and/or sub-sets of movable ground engaging structures 104 may be provided with separately adjustable speed control mechanisms 120, such that different individual ones and/or subsets of moveable ground engaging structures 104 may be operated simultaneously at different speeds.

In accordance with an illustrative embodiment, speed control mechanism 120 preferably is configured to control the speed of movement of robot 100 in response to one or more speed control signals 122. For example, speed control mechanism 120 may include solenoids or other electro-mechanical devices operable in response to speed control signals 122 to adjust the speed of robot 100 by, for example, changing the engagement of selected gears or other structures in speed control mechanism 120 in response to speed control signals 122. Alternatively, speed control signals 122 may control the movement speed of robot 100 by controlling the speed of motor 110, in the case where motor 110 is coupled more directly to moveable ground engaging structures 104.

Direction control mechanism 124 is configured in accordance with an illustrative embodiment to change a direction of movement of robot 100 in response to one or more direction control signals 126. Direction control mechanism 124 may include, for example, one or more moveable ground engaging structures 104 that are moveable in a manner so as to alter the direction of movement of robot 100. For example, direction control mechanism 124 may include one or more wheels 106 that are moveable by direction control mechanism 124, using, for example, a solenoid or appropriate stepper or other motor, so as to change an angle of the axis of rotation of such wheels 106 with respect to body 102, thereby to steer the direction of movement of robot 100 in a conventional manner. Alternatively, direction control mechanism 124 may be implemented as part of or as an additional function to speed control mechanism 120. In this case, direction control mechanism 124 may employ speed control mechanism 120 as described above, for example, to impart different drive speeds simultaneously to moveable ground engaging structures on opposite sides of body 102, thereby changing the direction of movement of robot 100 in a known manner.

Storage structure 128 may be provided on body 102 for storing mitigation material 130. For example, mitigation material 130 may include chemicals and/or other materials used for melting or otherwise mitigating ice or for mitigating the slipperiness of ice or other slippery materials detected on a surface, such as by increasing the surface co-efficient of friction. Mitigation materials 130 may include known materials and materials which may become known for such purposes in the future. For example, for ice mitigation, salt 132 and sand 134, such as heated sand, are preferred ice mitigation materials 130. For mitigating slipperiness caused by grease or oil spills, mitigation materials 130 may include sand or another absorbent material for absorbing grease or oil and providing friction. Mitigation materials 130 may include mixes of materials, such as a mixture of salt and sand. Mitigation materials 130 may be in any physical form, including solid particles, a liquid, or a slurry. The implementation of storage structure 128 will depend on the nature of mitigation materials 130 to be stored therein.

Mitigation material 130 may be loaded into storage structure 128 automatically or semi-automatically from a stockpile of mitigation material 136 stored in base station 116, when robot 100 is positioned in base station 116, as will be discussed in more detail below. Level sensor 138 may be mounted in, on, or adjacent to storage structure 128 to provide for detecting and monitoring the level of material 130 remaining in storage structure 128. Thus, level sensor 138 may be used to determine when mitigation material 130 in storage structure 128 is depleted, or almost depleted, and thus when robot 100 should return to base station 116 in order to refill storage structure 128 with mitigation material 136 from base station 116. Level sensor 138 also may be used to monitor the level of mitigation material 130 in storage structure 128 during the process of filling storage structure 128 with mitigation material 130, to ensure that structure 128 is filled to at least a desired level, but not overfilled, with material 130. The implementation of level sensor 138 will depend upon the nature of mitigation material 130 to be monitored, and may include mechanical or electromechanical sensors for determining the weight of material 130 in storage structure 128 and/or optical or other sensors for determining a level of material 130 in storage structure 128.

Mitigation material distribution structure 140 is provided on body 102 for distributing mitigation material 130 from storage structure 128 onto surface areas where the presence of ice or another slippery material is detected. Distribution structure 140 may include a valve or other structure for selectively releasing mitigation material 130 from storage structure 128 as well as a structure for directing released material 130 to the desired location on a surface. The implementation of material distribution structure 140 will depend upon the nature of mitigation material 130 to be distributed thereby. For example, for salt particles 132, sand 134, or the like, distribution structure 140 may include a conventional rotating spreader for throwing material 130 onto ice detected on a surface. Where mitigation material 130 is a fluid, distribution structure 140 may include a spray nozzle or similar structure for directing the fluid onto the surface.

In operation, ice mitigating robot 100 in accordance with an illustrative embodiment traverses a path across a surface, monitors the surface for the presence of ice or other slippery materials as it traverses the surface, and takes mitigating action in response to the detection of ice or another slippery material on the surface. Preferably these functions of robot 100 are performed automatically, with little or no human intervention, under control of robot controller 142. Controller 142 may be implemented in any manner appropriate for implementing the various functions of an ice mitigating robot in accordance with an illustrative embodiment to be described herein. For example, controller 142 may include processor 144 which may be implemented using a microprocessor, microcontroller or another type of programmable device. Controller 142 also may be implemented using discrete logic circuit components, or using any appropriate combination of programmable devices and/or discrete circuit components. To the extent that programmable devices such as processor 144 are used to implement controller 142, one or more functions of controller 142 may be implemented in software and/or firmware that is run on the programmable device and that is stored in memory in the programmable device and/or in a separate memory device coupled to the programmable device.

Path 146 to be traversed by ice mitigating robot 100 in accordance with an illustrative embodiment may be defined in advance and stored in memory or by some other method or structure for use by controller 142. Path 146 may be defined by a series of way-points between which robot 100 is to travel or as an area that is to be covered by robot 100 and an algorithm that is to be employed by controller 142 to determine a path of movement through the area. Alternatively, path 146 may be defined externally to robot 100 by markers and/or signals disposed in an area to be covered by robot 100 and that define path 146. For example, path 146 may be defined by a wire positioned below or imbedded in a walkway and/or parking lot that defines a path along the walkway and/or through the parking lot that robot 100 is to traverse.

Controller 142 implements movement control function 148 to control movement of robot 100 along path 146. For example, movement control function 148 may include the generation of speed control signals 122 and direction control signals 126 that are provided to speed control mechanism 120 and direction control mechanism 124, respectively, in order to control the speed and direction of movement of robot 100 in the manner described above to direct robot 100 along path 146.

In order to keep on designated path 146, controller 142 may employ position determination function 150 to determine the current position of robot 100. Based on the determined current position, controller 142 controls the speed and direction of movement of robot 100 to keep robot 100 moving along path 146 in the desired manner.

Position determination function 150 may make use of input provided by one or more localization perception devices 152. Various different devices and/or methods may be used for localization perception 152. Localization perception devices 152 and/or methods to be employed may depend upon how path 146 is defined. For example, where path 146 is defined by a wire positioned below or embedded in a walkway or parking lot, localization perception 152 may include device 154 for detecting a low power electrical signal carried by the wire. Localization perception 152 may include optical or other devices for detecting naturally occurring or placed landmarks 156 or markers positioned in the area traversed by robot 100. Based on the detection of such landmarks having known positions, the current position of robot 100 may be determined by triangulation. As another alternative, the current position of robot 100 may be determined using the Global Positioning System (GPS) or another system using remote signals for positioning. In this case, localization perception 152 may include a GPS or other positioning system receiver 158.

In accordance with an illustrative embodiment, as robot 100 traverses path 146, controller 142 implements an ice detection function 160 or other function for detecting ice or other slippery areas along path 146. Controller 142 may implement ice detection function 160 with input from one or more ice detector devices 162 that may employ one or more ice detection methods. Any device or method for detecting the presence of ice, ice-like material, such as packed snow, or other slippery material on a surface may be used to implement ice detector 162, including currently known devices and methods and devices and methods that may become known in the future. For example, ice detector 162 may include radiation device 164 for directing radiation having desired characteristics, such as microwave or optical frequency radiation, at the surface and for detecting the presence of ice by detecting and analyzing characteristics of the radiation reflected back from the surface, such as light beam scattering. Ice detector 162 may include physical structure 166, such as a roller or drag wheel, in contact with the surface and from which the presence of ice or other slippery material may be determined by detected movement of the physical structure, such as traction slippage, as areas of lower and higher friction are encountered by physical structure 166. As another alternative, ice detector 162 may include electrical detection device 168 for detecting the presence of ice based on electrical characteristics of the surface, such as by detecting the capacitive differences exhibited by different materials that may be present on the surface.

Ice detector 162 may also or alternatively employ a plurality of sensors in combination to detect the presence of ice or another slippery material on a surface. For example, an infrared or other range spectrograph may be used to detect water on a surface. A temperature sensor may be used to detect the surface temperature. If water is detected along with a surface temperature of 0° C. or below, the presence of ice on the surface may be assumed.

In response to the detection of ice, or another slippery material, controller 142 implements a mitigation control function 170 whereby robot 100 is controlled to take an action to deal with or mitigate in some way the potential hazard posed by the presence of the detected ice or other material. In accordance with an illustrative embodiment, one or more ice mitigation systems 172 and/or methods may be employed by the mitigation control function 170.

In accordance with an illustrative embodiment, ice mitigation 172 may include applying a mitigation material 174 to the detected slippery area. Applying mitigation material 174 may include activating material distribution structure 140 to distribute ice mitigation or other material 130 from storage structure 128 onto the slippery area in the manner described above. In this case, ice mitigation system 172 includes storage structure 128, material distribution device 140, ice mitigation material 130, such as salt 132 and/or sand 134, as well as the necessary power and control interfaces to provide for operation and control of material distribution structure 140 by controller 142.

Ice mitigation system 172 may also or alternatively include mechanism 176 for physically scoring or breaking-up ice on a surface, thereby to make the surface less slippery and to accelerate melting of the ice. In this case, ice mitigation system 172 may include structures such as blades or hammers that are driven physically against the detected ice to score or break it, as well as the necessary power and control interfaces to provide for operation and control of such scoring and/or breaking mechanism 176.

Ice mitigation system 172 may also or alternatively include one or more systems 178 for melting ice by the application of radiation or heat. For example, in this case ice mitigation system 172 may include a flaming torch or other mechanism or method for directing heat at the detected ice to melt it. Directed microwaves may be used to melt the ice. Also, or alternatively, a laser beam having a wavelength that is preferentially absorbed by ice may be used to heat and remove the ice. In any case, ice mitigation system 172 also will include the necessary power and control interfaces to provide for operation and control of such systems 178 for melting ice by directed radiation and/or heat.

Ice mitigation system 172 also or alternatively may include system 180 for reporting the location of detected ice or other slippery material to remote mitigation system 182. Remote mitigation system 182 includes any system or method for mitigating the potential hazard of ice or other slippery material detected by robot 100 that is not provided directly by robot 100 itself. In this case, ice mitigation system 172 may include a conventional transmitter 184, such as a conventional radio frequency transmitter, for transmitting a report including the location of detected ice or other slippery material to remote mitigation system 182. Transmitter 184 preferably may be coupled to appropriate antenna 186, which may be mounted on body 102. The transmitted report, indicating the location of detected ice or other slippery material, may be generated by controller 142 using location information provided by position determination function 150 at the time that ice or another slippery material is detected by ice detection function 160.

In accordance with an illustrative embodiment, remote mitigation 182 may include manual 188 and/or automatic 190 ice mitigation systems and functions. Manual mitigation 188 may include, for example, mitigation by human action based on the location report provided by robot 100. For example, a human may respond to such a report by manually applying a mitigation material to the reported slippery spot, or otherwise by removing the slippery material, such as by scraping away a patch of ice or cleaning-up spilled oil or grease. As another alternative, such manual mitigation 188 may be performed by or with the help of an automated or semi-automated machine, such as another robot, that performs or helps to perform the mitigation functions that may be performed by a human person.

Automatic remote mitigation 190 may include, for example, automatically activating a selected heating zone 192 installed beneath a surface to melt ice on the surface when the report from robot 100 indicates that ice is present in such a zone. For example, a parking lot or other surface may be divided into multiple zones. Each zone is provided with an independently controllable heating system. Such a heating system may include conduits for carrying steam or hot water or heat generating electrical elements positioned below or embedded in the parking lot.

In accordance with an illustrative embodiment, heating systems for the various zones may be controlled based on the signal or report from robot 100 indicating that there is ice present in the zone or ice present in the zone exceeding at least one threshold value. The heating system in a zone where the ice threshold is exceeded may be activated automatically. The threshold value may include, but is not necessarily limited to, one of the following: a percentage of zone area covered by ice, the presence of ice at a location in the zone and a probability that a person would be at that location, and/or a probability that ice will form in an area of the zone so preventive action can be taken. The probability that a person may cross a particular icy area of a zone may take into account factors such as the fact that ice is more dangerous in parking lot areas between cars than underneath cars, that certain times, such as weekdays, are more critical for ice removal than others, such as weekends, and/or other similar or different factors.

Heating zones 192 that are activated to remove ice will remain activated until deactivated. Deactivation of a heating zone 192 may be initiated automatically in response to a report or signal from robot 100 that ice is no longer detected above the threshold value in the location where it was detected previously. Alternatively, an activated heating zone 192 may be deactivated automatically after a set elapsed time or after a variable elapsed time based on at least one environmental factor related to the melting rate of ice, such as the measured amount of ice to be melted, ambient air temperature, wind speed, and the like.

In illustrative embodiments where ice mitigation 172 includes applying mitigation material 130 from storage structure 128, it is apparent that the amount of material 130 in storage structure 128 will become depleted as it is used. Controller 142 preferably monitors the level of material 130 in storage structure 128 using a material monitoring function 194. Material monitoring function 194 may employ the output from material level sensor 138, described previously, in order to determine the level of material 130 in storage structure 128 at any given time. As will be discussed in more detail below, in response to a determination that the level of material 130 in storage structure 128 is below a selected level, controller 142 may control the movement of robot 100 to direct robot 100 to return to base station 116 for reloading of material 130 into storage structure 128 from the stockpile of mitigation material 136 stored at base station 116.

In illustrative embodiments where motor 110 is an electric motor powered by battery 112, controller 142 preferably monitors the remaining power or charge level of battery 112 using a power monitoring function 196. As will be discussed in more detail below, in response to a determination that the power level of battery 112 is below a selected level, controller 142 may control the movement of robot 100 to direct robot 100 to return to base station 116 for recharging of battery 112 from charging power 118 provided at base station 116 via charging connector 114. Alternatively, controller 142 may take other action in response to a determination that the power level of battery 112 is low, such a sending a message to a human operator that recharging is, or soon will be, required.

Controller 142 preferably also implements safeguarding function 198 to prevent damage to robot 100 and things in the robot's environment. Safeguarding function 100 may employ input provided by one or more safeguarding perception devices 199. For example, safeguarding perception devices 199 may include optical, sonic, and/or physical contact sensors that provide signals to controller 142 from which the presence of potentially damaging situations may be detected. Safeguarding function 198 may be employed by controller 142 to stop robot 100 or alter its direction and/or speed of movement in response to the detection of a potentially damaging situation.

Power for the various electrical components of robot 100, including electrical components of controller 142, level sensor 138, localization perception 152, ice detector 162, ice mitigation 172, and safeguard perception 199, may be provided, for example, by main system battery 112 or by a separate appropriate rechargeable battery which may be used exclusively to power such components. Preferably an appropriate charging mechanism is provided to charge such a separate battery, for example, while robot 100 is positioned at base station 116 and main system battery 112 is being charged.

The illustration of FIG. 1 is not meant to imply physical or architectural limitations to the manner in which different advantageous embodiments may be implemented. Other components in addition and/or in place of the ones illustrated may be used. Some components may be unnecessary in some advantageous embodiments. Also, the blocks are presented to illustrate some functional components. One or more of these blocks may be combined and/or divided into different blocks when implemented in different advantageous embodiments.

For example, base station 116 in FIG. 1 is shown to provide for both battery charging 118 and mitigation material 136 reloading. Alternatively, each of these functions may be provided separately, for example, at separate recharging and material reloading stations. Furthermore, base stations 116 may be mobile or stationary, and mitigation material 136 and charging power 118 may be distributed across a number of stationary and/or mobile base stations 116.

When it is stated herein that a structure is attached to body 102, such structure may be attached directly to body 102 or indirectly to body 102 via an intermediate structure.

Various functional components of robot 100, such as motor 110, speed control mechanism 120, direction control mechanism 124, and material distribution mechanism 140, will include appropriate mechanical, electrical, and/or electro-mechanical devices and/or structures in appropriate combinations for converting control signals from controller 142, such as speed control signals 122 and direction control signals 126, into the appropriate mechanical action in these components. The particular devices and/or structures to be employed will depend upon the implementation of the functional components for a particular robot 100 or application thereof in accordance with an illustrative embodiment, and will be known to those having skill in the art.

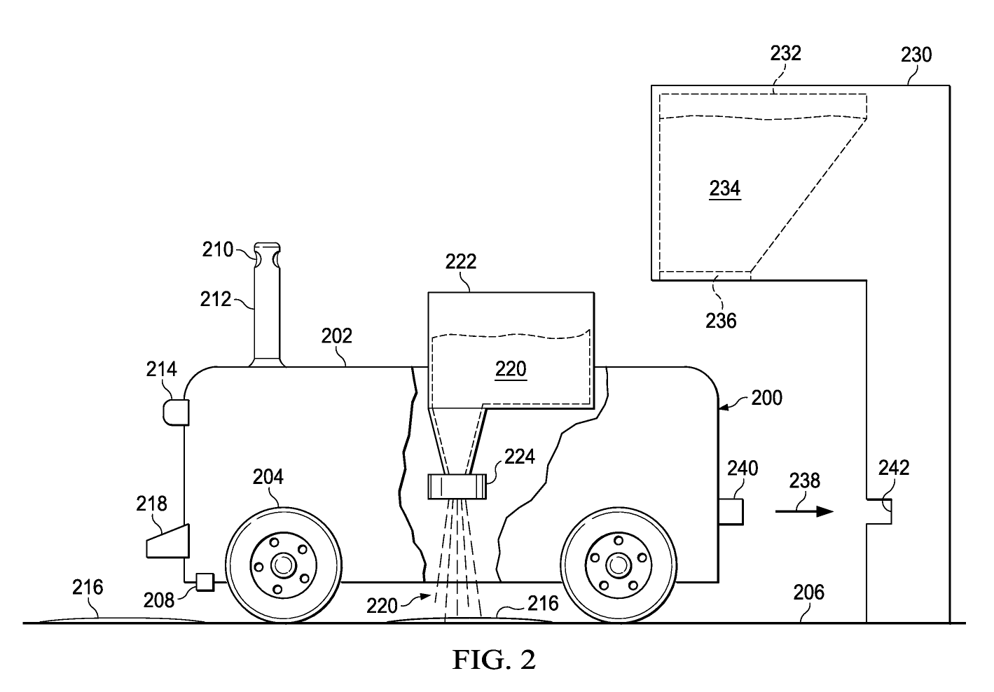

Operation of ice mitigating robot 200 in accordance with an illustrative embodiment is described in more detail with reference to FIG. 2, showing a side view representational illustration of robot 200 in partial cross-section. In this example, robot 200 is an example of one implementation of ice mitigating robot 100 in FIG. 1. FIG. 2 also shows a side view representational illustration of base station 230. In this example, base station 230 is an example of one implementation of base station 116 in FIG. 1.

Ice mitigating robot 200 includes body 202 supported by wheels 204. In this example, wheels 204 are an example of movable ground engaging structures 104 in FIG. 1. As described above, wheels 204 are driven to propel robot 200 automatically across surface 206 along a path.

In order to determine its position on surface 206, robot 200 may employ one or more devices for localization perception. For example, where the path is defined by a wire or markers on or below surface 206, localization perception device 208 may be mounted at or near the bottom of body 202. For example, localization perception device 208 may include a device for detecting a signal in a wire embedded in surface 206 for defining the path of travel of robot 200 or may include a device for detecting metal markers embedded in surface 206 for defining the path of travel of robot 200. As another example, localization perception device 210 may include optical or other detectors for detecting natural or placed landmarks or markers positioned on or adjacent to surface 206. Such localization perception devices 210 may be elevated, such as by mounting at or near the top of a vertical post 212 extending upward from body 202, such that the line of sight between perception devices 210 and the landmarks or markers is less likely to be obscured by mounds of snow or other obstructions that are likely to be found on or adjacent to surface 206 at times when robot 200 is in operation to detect and mitigate ice on surface 206.

As discussed above, one or more safeguarding perception devices 214 also may be mounted on body 202. For example, safeguarding perception devices 214 may include optical, sonic, and/or physical contact sensors that provide signals for indicating the detection of objects or surface features that may be hazardous to robot 200 and/or the detection of things in the path of robot 200 that might be harmed or damaged by robot 200. As discussed above, the direction and/or speed of movement of robot 200 may be adjusted in response to the detection of a potentially damaging situation by safeguarding perception devices 214.

In accordance with an illustrative embodiment, as robot 200 traverses surface 206 it implements an ice detection function for detecting the presence of ice 216 or another slippery material on surface 206. As discussed above, this ice detection function may be implemented using one or more ice detection devices 218 and/or methods. Ice detection device 218 may include, for example, a device that transmits a signal having desired frequency and/or other characteristics downward from robot 200 onto surface 206 and which receives the resulting signal reflected back from surface 206. In this case, ice detection device 218 may be mounted at or near the bottom of body 202. As discussed in more detail above, the received reflected signal may be analyzed by robot 200 to determine the presence of ice 216 or another material on surface 206. When ice 216 or another material is detected on surface 206, the current position of robot 200 at the time of detection, as determined using localization perception devices 208 and/or 210, may be used to locate more or less precisely the position of ice 216 or another detected slippery material on surface 206.

In accordance with an illustrative embodiment, when robot 200 detects the presence of ice 216 or another slippery material on surface 206, robot 200 may take action automatically to mitigate the potential hazard presented by ice 216 or other material. For example, such mitigating action may include applying mitigation material 220 onto ice 216 or other detected slippery area on surface 206. Since robot 206 determines the location of ice 216 or other slippery material on surface 206, mitigation material 220 may be applied with relative precision directly onto ice 216 or other slippery area. Since mitigation material 220 thus may be applied only where it is needed, and need not be applied across the entirety of surface 206, the amount of mitigation material needed to deal with ice 216 or other slippery areas detected on surface 206 is minimized. Therefore, the total cost of mitigation material 220 used and the potential impact of mitigation material 220 on the environment also may be minimized using robot 200 in accordance with an illustrative embodiment.

As discussed above, mitigation material 220 to be used may be selected depending upon the slippery material, such as ice 216 or another material, on surface 206 to be mitigated. For example, for the mitigation of ice 216, ice mitigation material 220 may include salt, sand, heated sand, or a mixture of salt and sand. Mitigation material 220 is carried in appropriate storage structure 222 on robot 200. The implementation of storage structure 222 may depend on the nature of mitigation material 220 to be stored therein, such as, for example, whether mitigation material 220 consists of solid particles or a liquid. In any case, a structure, such as valve structure 224, preferably is provided to allow for selective release of mitigation material 220 from storage structure 222 for application of mitigating material 220 onto surface 206 only where it is needed, such as where ice 216 or another slippery material is detected on surface 206. The implementation of valve structure 224 may depend on the nature of mitigation material 220 to be controlled thereby, such as, for example, whether mitigation material 220 consists of solid particles or a liquid.

As mitigation material 220 is applied by robot 200 onto surface 206, the supply of mitigation material 220 in storage structure 222 will become depleted. As discussed above, in accordance with an illustrative embodiment, when the supply of mitigation material 220 in storage structure 222 on robot 200 is depleted, or is depleted to a certain level, robot 200 may be controlled to return automatically to base station 230.

In accordance with an illustrative embodiment, base station 230 includes base station storage structure 232 containing a stockpile of mitigation material 234 ready to be transferred to robot 200. The implementation of base station storage structure 232 may depend upon the nature of mitigation material 234 to be stored therein, such as, for example, whether mitigation material 234 comprises solid particles or a liquid. Release mechanism 236, such as a valve or door, is provided for selectively releasing mitigation material 234 from storage structure 232 when robot 200 is positioned for resupply of mitigation material from base station 230. The implementation of release mechanism 236 also may depend on the nature of mitigation material 234 stored in base station 230.

In accordance with an illustrative embodiment, when robot 200 is moved into an appropriate position with respect to base station 230, in the direction of arrow 238 in FIG. 2, storage structure 222 on robot 200 is aligned with release mechanism 236 on base station 230. In this position, release mechanism 236 may be actuated to release mitigation material from storage structure 232 on base station 230 into storage structure 222 on robot 200.

Control of release mechanism 236 may be implemented in any desirable and appropriate manner. For example, release mechanism 236 may be implemented as a mechanical structure that is actuated by movement of robot 200 into the desired position with respect to base station 230 to release a set amount of mitigation material 234 from storage structure 232 on base station 230 into storage structure 222 on robot 200. Alternatively, release mechanism 236 may be controlled electronically, for example, in response to sensing that robot 200 is in the desired position with respect to base station 230, to release either a fixed or variable amount of mitigation material 234 from storage structure 232 on base station 230 into storage structure 222 on robot 200. For example, the output of a mitigation material level sensing device on robot 200, as described above, may be used to control release mechanism 236 to continue to release material 234 from storage structure 232 on base station 230 into storage structure 222 on robot 200 until it is determined that the level of material 220 in storage structure 222 on robot 200 has reached a desired level. In this case, conventional means may be provided for providing the mitigation material level information from robot 200 to base station 230 for control of release mechanism 236.

As discussed above, in accordance with an illustrative embodiment, robot 200 may include charging connector 240 for providing electrical power to robot 200 for charging the robot system battery. Base station 230 may provide such charging power via complementary charging connector 242. Charging connectors 240 and 242 preferably may be designed and positioned on body 202 of robot 200 and on base station 230, respectively, such that charging connectors 240 and 242 are engaged to provide charging power from base station 230 to robot 200 when robot 200 is positioned with respect to base station 230 for the refilling of mitigation material from base station 230.

In an alternative embodiment, electrical power for battery charging may be provided from base station 230, or from another source of power, to robot 200 using a wireless power transfer means, without requiring a physical electrical connection. In this case, charging connector 240 may include appropriate structures for coupling to the wireless power source, such as antenna or other structures for wireless electromagnetic coupling.

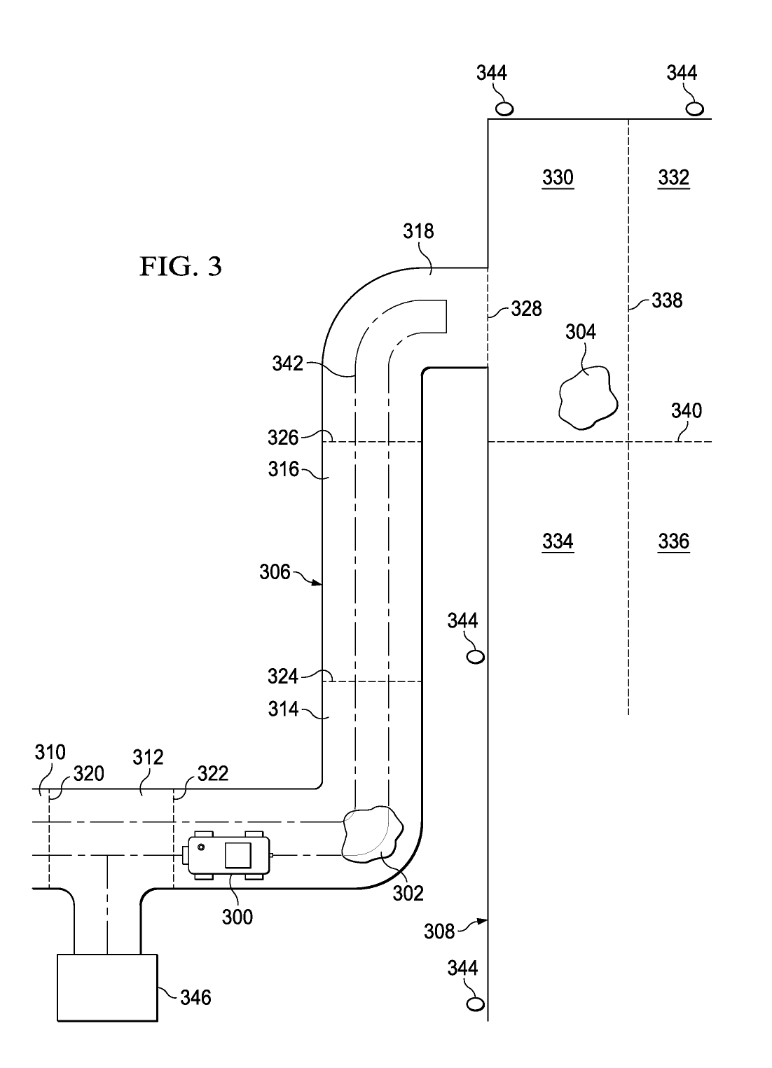

Operation of ice mitigating robot 300 in accordance with an illustrative embodiment to mitigate potentially hazardous patches of ice 302 and 304 on walkway 306 and parking lot 308, respectively, is described with reference to FIG. 3. FIG. 3 shows robot 300 and portions of walkway 306 and parking lot 308 from above. In this example, ice mitigating robot 300 is an example of another implementation of ice mitigating robot 100 in FIG. 1.

In accordance with an illustrative embodiment, walkway 306 is divided into sections or zones 310, 312, 314, 316, and 318, as indicated by dotted lines 320, 322, 324, 326 and 328. In this example, each zone 310, 312, 314, 316, and 318 of walkway 306 includes an independently controllable mechanism for heating the corresponding zone to melt any ice found on that zone. Similarly, parking lot 308 is divided into sections or zones 330, 332, 334, and 336, as indicated by dotted lines 338 and 340. In this example, each zone 330, 332, 334, and 336 of parking lot 308 includes an independently controllable mechanism for heating the corresponding zone to melt any ice found on that zone. As discussed above, the independently controllable heating mechanisms may include conduits for carrying steam or hot water or electrical wire heating elements positioned below or embedded in zones 310, 312, 314, 316, and 318 of walkway 306 and zones 330, 332, 334 and 336 of parking lot 308.

In accordance with an illustrative embodiment, robot 300 is controlled to traverse automatically a path across walkway 306 and parking lot 308. Path 342 along walkway 306 is illustrated by the dashed line in FIG. 3. Path 342 may be defined, for example, by a wire positioned below or embedded in walkway 306. Robot 300 may include an appropriate localization perception device for detecting a signal in the wire in order that robot 300 may be controlled to traverse path 342 in the manner described above. A path for robot 300 through parking lot 308 may be defined by a map or algorithm in the robot controller. Landmarks 344, such as naturally occurring or placed landmarks 344, may be positioned around parking lot 308. Robot 300 may include an appropriate localization perception device for detecting landmarks 344, so that the position of robot 300 on parking lot 308 may be determined by triangulation and so that robot 300 may be controlled to follow the defined path through parking lot 308. Other methods and systems may be employed in accordance with an illustrative embodiment for defining paths for robot 300 across walkway 306 and parking lot 308 and for localization perception for robot 300 on walkway 306 and parking lot 308, as discussed above.

In accordance with an illustrative embodiment, robot 300 automatically detects for the presence of ice on the surface of walkway 306 as robot 300 traverses path 342 on walkway 306, and automatically detects for the presence of ice on the surface of parking lot 308 as robot 300 traverses a defined path across parking lot 308. Thus, as robot 300 traverses path 342 it will detect and localize potentially hazardous patch of ice 302 on walkway 306. As robot 300 traverses parking lot 308 it will detect and localize patch of ice 304.

In accordance with an illustrative embodiment, as each patch of ice 302 and 304 is detected by robot 300, robot 300 takes action to mitigate the potential hazard presented by ice patches 302 and 304. For example, robot 300 may apply mitigation material to ice patches 302 and 304, as described above. Robot 300 may also or alternatively report the position of detected ice patches 302 and 304 to a remote mitigation system external to robot 300. In response to such a report from robot 300 for detected ice patches 302 and 304, the remote mitigation system may activate the independently controllable ice melting mechanisms associated with zone 314 of walkway 306 and with zone 330 of parking lot 308, respectively, thereby to melt detected ice patches 302 and 304 in the manner described above.

In accordance with an illustrative embodiment, robot 300 may monitor remaining available battery power or the charge level of a system battery of robot 300, as described above. Robot 300 also may monitor a level of mitigation material in a storage structure on robot 300, as described above. If either the available battery power or level of mitigation material is found to be below certain levels, robot 300 may be controlled automatically to return to base station 346. In this example, base station 346 is an example of one implementation of base station 116 in FIG. 1. As described above, base station 346 may provide for recharging the system battery of robot 300 and/or reloading the mitigation material in the storage structure on robot 300. In this example, base station 346 is located on path 342. Thus, robot 300 may be controlled to return to base station 346 by following path 342 in the manner described above.

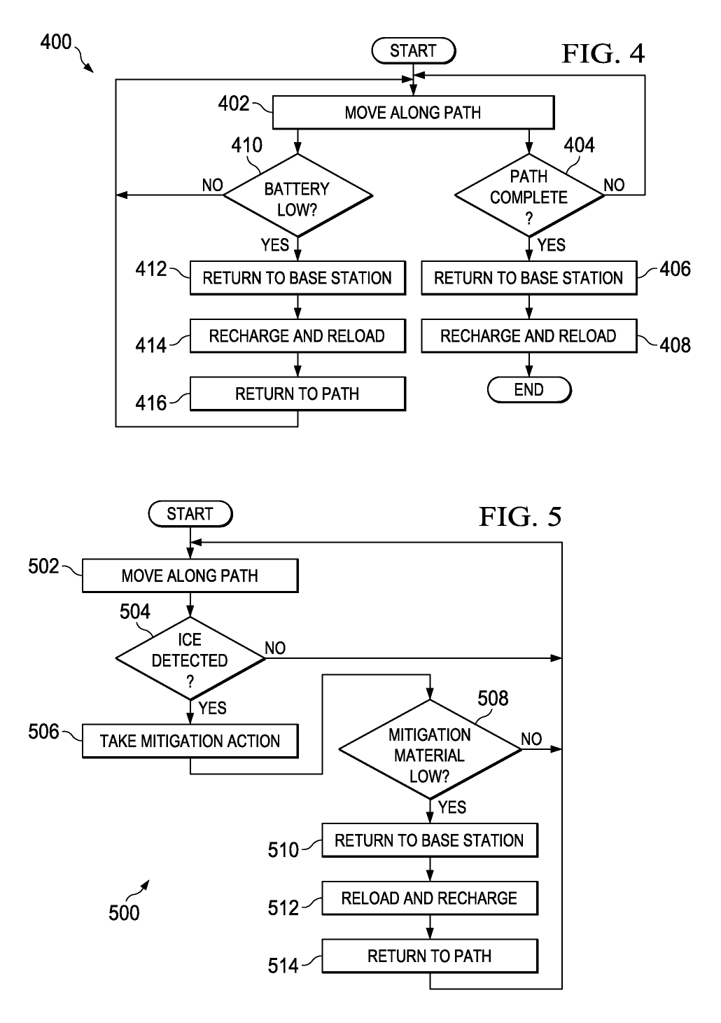

Method 400 for controlling the movement of an ice mitigating robot in accordance with an illustrative embodiment is described with reference to the flowchart diagram of FIG. 4. Method 400 may be initiated manually, such as by a human operator, or automatically. For example, method 400 may be initiated automatically at certain times and/or under certain conditions, such as in response to the detection or report of weather conditions indicating that the formation of hazardous ice on the surface to be traversed by the ice mitigating robot is likely. Method 400 may be repeated automatically, for example, until stopped by a human operator, until a selected time period expires, or until the detected or reported weather conditions indicate that ice formation is no longer likely.

As discussed previously, an ice mitigating robot in accordance with an illustrative embodiment is controlled to move automatically along a path (step 402). Step 402 may include the use of one or more localization perception devices employed by the robot to determine its position as it moves across a surface and thus to control the position of the robot as it moves along the path. As discussed above, the path to be traversed by the robot may be defined in a variety of ways.

In accordance with an illustrative embodiment, the ice mitigating robot is controlled to traverse automatically the path until the robot has completed traversing the entire defined path or a selected portion thereof (step 404). After completely traversing the path, an ice mitigating robot in accordance with an illustrative embodiment may be controlled to return automatically to a base station (step 406). As discussed previously, at the base station, the robot system battery may be recharged and the robot reloaded with ice mitigation material (step 408).

In accordance with an illustrative embodiment, while the ice mitigating robot is traversing a path, the robot continuously or periodically checks the available system battery power or level of charge to determine whether or not a low battery condition exists (step 410). When a low battery condition is determined to exist, the ice mitigating robot may be controlled to return automatically to a base station (step 412). At the base station, the robot system battery may be recharged and the robot reloaded with ice mitigation material (step 414). After reloading and recharging, the robot may be controlled to return automatically to the path (step 416) to continue traversing the path in the normal manner. Step 416 preferably may include using one or more localization perception devices in order to control the robot to return automatically to the position on the defined path at which the low battery condition was detected, and to continue traversing the path from that point.

Method 500 for controlling an ice mitigating robot in accordance with an illustrative embodiment to detect ice or another slippery material on a surface and to take action to mitigate the potential hazard presented by the detected ice or other slippery material is described with reference to the flowchart diagram of FIG. 5. In accordance with an illustrative embodiment, the steps of method 500 may take place in parallel with the steps of method 400 of FIG. 4.

An ice mitigating robot in accordance with an illustrative embodiment is controlled to move automatically across a surface along a path (step 502), such as in a manner described previously. As the robot traverses the surface, the robot preferably continuously or substantially continuously detects for the presence of ice or other slippery materials on the surface (step 504). Step 504 may include using one or more ice detection devices and/or methods to detect the presence of ice on the surface as well as one or more localization perception devices to determine the location of the robot on the surface where the presence of ice or another slippery material is detected.

In accordance with an illustrative embodiment, when the presence of ice or another slippery material on the surface is detected by the robot, the robot automatically takes action to mitigate the potential hazard (step 506). As discussed previously, step 506 may include applying a mitigation material to the surface, physically scoring or breaking the detected ice, melting the ice with heat or other radiation, and/or reporting the location of detected ice to a remote mitigation system.

In cases where an ice mitigating robot in accordance with an illustrative embodiment employs mitigation material, the robot preferably continuously or periodically monitors a level of mitigation material stored on the robot to detect whether the level of mitigation material is running low (step 508). In response to a determination that the level of mitigation material on the robot is running low, an ice mitigating robot in accordance with an illustrative embodiment preferably is controlled to return automatically to a base station (step 510). At the base station, the robot is reloaded with ice mitigation material and the robot system battery may be recharged (step 512). After reloading and recharging, the robot may be controlled to return automatically to the path (step 514) to continue traversing the path in the normal manner. Step 514 preferably may include using one or more localization perception devices in order to control the robot to return automatically to the position on the defined path at which the low mitigation material condition was detected, and to continue traversing the path from that point.

An ice mitigating robot and methods for controlling and using an ice mitigating robot in accordance with illustrative embodiments are disclosed. One or more illustrative embodiments provide a capability to detect automatically ice or other slippery materials on a surface and to take action automatically to mitigate the potential hazard presented by the ice or other slippery materials with little or no human intervention.

The flowcharts and block diagrams in the different depicted embodiments illustrate the architecture, functionality, and operation of some possible implementations of apparatus and methods in different advantageous embodiments. In this regard, each block in the flowcharts or block diagrams may represent a module, segment, function, and/or partition of an operation or step. In some alternative implementations, the function or functions noted in the block may occur out of the order noted in the figures. For example, in some cases, two blocks shown in succession may be executed substantially concurrently, or the blocks may sometimes be executed in the reverse order, depending on the functionality involved. Also, other blocks may be added in addition to the illustrated blocks in a flowchart or block diagram.

The description of the different advantageous embodiments has been presented for purposes of illustration and explanation, and is not intended to be exhaustive or to limit the embodiments to the form disclosed. Many modifications and variations will be apparent to those of ordinary skill in the art. Further, different embodiments may provide different advantages as compared to other embodiments. The embodiment or embodiments selected are chosen and described in order to best explain the principles of the invention, the practical application, and to enable others of ordinary skill in the art to understand the invention for various embodiments with various modifications as are suited to the particular use contemplated.

What is claimed is:

1. An apparatus, comprising:
a body;
movable ground engaging structures attached to the body;
a motor coupled to the moveable ground engaging structures and configured to drive the moveable ground engaging structures to move the apparatus across a surface;
a detector configured to detect a slippery material on the surface; and
a controller coupled to the detector and configured to control automatically movement of the apparatus across the surface along a path, and to control the apparatus to perform automatically an action to mitigate the slippery material in response to the detection of the slippery material on the surface.

2. The apparatus of claim 1, wherein the moveable ground engaging structures are selected from the group of movable ground engaging structures consisting of wheels, tracks, and legs.

3. The apparatus of claim 1, wherein the motor includes an electric motor powered by a battery.

4. The apparatus of claim 3, wherein the controller is configured to monitor a power level of the battery and to control automatically movement of the apparatus to move the apparatus to a location for charging the battery in response to a determination that the monitored power level of the battery is below a selected low power level.

5. The apparatus of claim 1, wherein the detector includes a detector configured to detect ice on the surface selected from the group of ice detection devices consisting of devices configured to detect ice from the reflection of radiation from the surface, devices configured to detect slippage of a physical structure in contact with the surface, and devices configured to detect ice from electrical characteristics of the surface.

6. The apparatus of claim 1, wherein the slippery material is ice and wherein the action to mitigate the slippery material includes an action selected from the group of actions consisting of physically scoring the ice, physically breaking the ice, melting the ice with heat, melting the ice with radiation directed from the apparatus onto the ice, and applying an ice mitigation material onto the ice.

7. The apparatus of claim 1, wherein the action to mitigate the slippery material includes applying a mitigation material onto the slippery material.

8. The apparatus of claim 7, wherein the mitigation material is selected from the group of mitigation materials consisting of a material that increases the surface co-efficient of friction, a material that melts the slippery material, and a material that absorbs the slippery material.

9. The apparatus of claim 7, comprising additionally a storage structure attached to the body, wherein the mitigation material is stored in the storage structure, and wherein the controller is configured to monitor a level of the mitigation material stored in the storage structure and to control automatically movement of the apparatus to move the apparatus to a location for loading mitigation material into the storage structure in response to a determination that the monitored level of mitigation material in the storage structure is below a selected low material level.

10. The apparatus of claim 1, wherein the action to mitigate the slippery material includes sending a determined location of the slippery material from the apparatus to a remote mitigation system.

11. The apparatus of claim 10, wherein the slippery material is ice, wherein the surface includes a plurality of zones, wherein the remote mitigation system includes an independently controllable apparatus associated with each zone and configured to be controllable to melt ice on the surface in a corresponding zone, and wherein the remote mitigation system is configured to control a selected independently controllable apparatus associated with a particular zone to melt ice on the surface in the particular zone in response to the determined location being in the particular zone.

12. A method of automatically detecting and mitigating a slippery material on a surface, comprising:
providing a mobile machine including a detector configured to detect a slippery material on the surface;
controlling automatically movement of the mobile machine across the surface along a path;
automatically detecting for a slippery material on the surface as the mobile machine is moved across the surface; and
automatically performing an action to mitigate the slippery material in response to the detection of the slippery material on the surface.

13. The method of claim 12, wherein the mobile machine includes an electric motor powered by a battery and further comprising monitoring a power level of the battery and controlling automatically movement of the mobile machine to move the mobile machine to a location for charging the battery in response to a determination that the monitored power level of the battery is below a selected low power level.

14. The method of claim 12, wherein the detector is configured to detect ice on the surface and wherein detecting for a slippery material on the surface includes a method of detecting ice on the surface selected from the group of ice detection methods consisting of detecting ice from the reflection of radiation from the surface, detecting slippage of a physical structure in contact with the surface, and detecting ice from electrical characteristics of the surface.

15. The method of claim 12, wherein the slippery material is ice and wherein the action to mitigate the slippery material includes an action selected from the group of actions consisting of physically scoring the ice, physically breaking the ice, melting the ice with heat, and melting the ice with radiation directed from the mobile machine onto the ice, and applying an ice mitigation material onto the ice.

16. The method of claim 12, wherein the action to mitigate the slippery material includes applying a mitigation material onto the slippery material.

17. The method of claim 16, wherein the mitigation material is selected from the group of ice mitigation materials consisting of a material that increases the surface co-efficient of friction, a material that melts the slippery material, and a material that absorbs the slippery material.

18. The method of claim 16, wherein the mitigation material is stored in a storage structure on the mobile machine, and further comprising monitoring a level of the mitigation material stored in the storage structure and controlling automatically movement of the mobile machine to move the mobile machine to a location for loading mitigation material into the storage structure in response to a determination that the monitored level of mitigation material in the storage structure is below a selected low material level.

19. The method of claim 12, wherein the action to mitigate the slippery material includes sending a determined location of the slippery material from the mobile machine to a remote mitigation system.

20. The method of claim 19, wherein the slippery material is ice, wherein the surface includes a plurality of zones, wherein the remote mitigation system includes an independently controllable apparatus associated with each zone and configured to be controllable to melt ice on the surface in a corresponding zone, and wherein the remote mitigation system is configured to control a selected independently controllable apparatus associated with a particular zone to melt ice on the surface in the particular zone in response to the determined location being in the particular zone.
